(19) United States
(12) Patent Application Publication
(10) Pub. No.: US 2018/0315135 A1
(43) Pub. Date: Nov. 1, 2018

(54) SYSTEMS AND METHODS FOR ESTIMATING DEGREE OF COMPLIANCE WITH RECOMMENDED CROP PROTOCOL

(71) Applicant: Tata Consultancy Services Limited, Mumbai (IN)

(72) Inventors: Sanat Sarangi, Thane (IN); Bhushan Gurmukhdas Jagyasi, Thane (IN); Somya Sharma, Thane (IN)

(73) Assignee: Tata Consultancy Services Limited, Mumbai (IN)

(21) Appl. No.: 15/926,654

(22) Filed: Mar. 20, 2018

(30) Foreign Application Priority Data
Apr. 27, 2017 (IN) 201721014956

(51) Int. Cl. G06Q 50/02; G06Q 30/00; G06Q 10/06; G06K 9/62

(52) U.S. Cl. CPC G06Q 50/02; G06K 9/6268; G06Q 10/06316; G06Q 30/018

(57) ABSTRACT

Traceability of agricultural activities is very critical to market compliance. Mere automation of traditionally monitored agricultural activities alone may not address the challenge of providing a simple yet flexible and predictable method of effective and real time monitoring of agricultural activities around the farm that may be used to compute crop protocol for any crop under consideration. The systems and methods of the present disclosure facilitate automatic identification of crop protocol irrespective of the type of the crop and agricultural activities associated thereof. Real time monitoring of the agricultural activities also enable farm personnel to conclude on effects of dynamic changes in crop protocol thereby allowing continuous building up of the repository of agro-climatic zone based information associated with the farm. Regulating crop protocol results in a predictable increase in efficiency and sustainability of crop yield that helps farm personnel to optimize productivity.

### PRIORITY CLAIM

This U.S. patent application claims priority under 35 U.S.C. § 119 to: Indian Patent Application No. 201721014956, filed on 27 Apr. 2017. The entire contents of the aforementioned application are incorporated herein by reference.

### TECHNICAL FIELD

The embodiments herein generally relate to package of practices for cultivation or crop protocols and more particularly to methods and systems for estimating degree of compliance with recommended crop protocol.

### BACKGROUND

Every crop has a package of practices for cultivation called the crop-protocol which a farmer has to comply with. To ensure that a farmer follows the crop protocol during cultivation, organized farms usually have farm diaries that maintain manual records for crop protocol for traceability. Crop protocol compliance is an essential component in order to achieve market compliance for the produce. In order to ascertain that the recommended crop protocol is being followed, the actual sequence of activities constituting the crop protocol has to be constructed from visual observation of activity in the crop stages and farm records which is a time-consuming and laborious process. Further, there may be situations where no records are maintained and not all activities are traceable which make the problem even more challenging.

### SUMMARY

Embodiments of the present disclosure present technological improvements as solutions to one or more of the above-mentioned technical problems recognized by the inventors in conventional systems.

In an aspect, there is provided a method comprising: receiving, by a data acquisition module, a plurality of input parameters associated with a farm, the input parameters being crop data, location data and a set of agricultural activity profiles associated with one or more farm personnel for a period of observation; determining, by an activity profiler module, at least one agricultural activity based on the set of agricultural activity profiles corresponding to each subset of the period of observation; generating, by an activity sequencing module, an agricultural activity sequence for the period of observation based on the at least one agricultural activity determined for each subset of the period of observation; and identifying, by an analyzer module, an observed crop protocol based on the agricultural activity sequence generated for the period of observation.

In another aspect, there is provided a system comprising: one or more processors; and one or more internal data storage devices operatively coupled to the one or more processors for storing instructions configured for execution by the one or more processors, the instructions being comprised in: a data acquisition module configured to receive a plurality of input parameters associated with a farm, the input parameters being crop data, location data and a set of agricultural activity profiles associated with one or more farm personnel for a period of observation; an activity profiler module configured to determine at least one agricultural activity based on the set of agricultural activity profiles corresponding to each subset of the period of observation, the at least one agricultural activity corresponding to the agricultural activity having a maximum frequency of occurrence identified for the subset of the period or a frequency of occurrence greater than a pre-defined threshold frequency for the subset of the period of observation based on a repository of agro-climatic zone based information associated with the farm; an activity sequencing module configured to generate an agricultural activity sequence for the period of observation based on the at least one agricultural activity determined for each subset of the period of observation; and an analyzer module configured to identify an observed crop protocol based on the agricultural activity sequence generated for the period of observation.

In yet another aspect, there is provided a computer program product comprising a non-transitory computer readable medium having a computer readable program embodied therein, wherein the computer readable program, when executed on a computing device, causes the computing device to: receive a plurality of input parameters associated with a farm, the input parameters being crop data, location data and a set of agricultural activity profiles associated with one or more farm personnel for a period of observation; determine at least one agricultural activity based on the set of agricultural activity profiles corresponding to each subset of the period of observation; generate an agricultural activity sequence for the period of observation based on the at least one agricultural activity determined for each subset of the period of observation; and identify an observed crop protocol based on the agricultural activity sequence generated for the period of observation.

In an embodiment of the present disclosure, one or more of the plurality of input parameters are obtained from at least one of: sensors deployed as at least one of (a) wearable devices and (b) farm or farm equipment mounted devices; and crowdsourcing from farm personnel associated with the farm.

In an embodiment of the present disclosure, the step of determining at least one agricultural activity comprises use of supervised-learning based classifiers configured to learn and identify an agricultural activity associated with an agricultural activity profile.

In an embodiment of the present disclosure, the at least one agricultural activity corresponds to the agricultural activity having a maximum frequency of occurrence identified for the subset of the period or a frequency of occurrence greater than a pre-defined threshold frequency for the subset of the period of observation based on a repository of agro-climatic zone based information associated with the farm.

In an embodiment of the present disclosure, the step of generating an agricultural activity sequence for the period of observation comprises generating a sequence of activity-segments, the activity-segments being associated with the identified at least one agricultural activity, the subset of the period of observation associated thereof and the location data associated thereof.

In an embodiment of the present disclosure, the step of identifying an observed crop protocol comprises: fusing two or more activity-segments to form an activity-segment sequence based on likeness of the associated at least one agricultural activity, the subset of the period of observation associated thereof, the location data associated thereof and position of the at least one agricultural activity in the agricultural activity sequence; and identifying anomalous agricultural activity in the activity-segment sequence based on length of the activity-segment, position of the activity-segment and the agro-climatic zone based information associated with the farm.

In an embodiment of the present disclosure, the method described herein above further comprises: estimating a degree of compliance of the observed crop protocol with reference to a recommended crop protocol available in the repository of agro-climatic zone based information associated with the farm by comparing the at least one agricultural activity associated with an activity-segment length in the period of observation with the corresponding at least one agricultural activity in the recommended crop protocol; assigning a deviation score based on the comparison; and concluding on dynamic changes in crop protocol associated with a crop under consideration based on the one or more activity segments that do not form part of both the activity-segment sequence of the observed crop protocol and the recommended crop protocol.

In an embodiment of the present disclosure, the method described herein above further comprises: generating an estimated forecast of the at least one agricultural activity based on the estimated degree of compliance.

In an embodiment of the present disclosure, the method described herein above further comprises defining the observed crop protocol as the recommended crop protocol for the crop under consideration if crop yield associated with the observed crop protocol is greater than crop yield associated with the recommended crop protocol in the repository of agro-climatic zone based information associated with the farm.

It is to be understood that both the foregoing general description and the following detailed description are exemplary and explanatory only and are not restrictive of the embodiments of the present disclosure, as claimed.

### BRIEF DESCRIPTION OF THE DRAWINGS

The embodiments herein will be better understood from the following detailed description with reference to the drawings, in which:

FIG. 1 illustrates an exemplary block diagram of a system for estimating degree of compliance with recommended crop protocol in accordance with an embodiment of the present disclosure;

FIG. 2 is an exemplary flow diagram illustrating a computer implemented method for estimating degree of compliance with recommended crop protocol using the system of FIG. 1 in accordance with an embodiment of the present disclosure;

FIG. 3 is an exemplary schematic representation of determining one or more agricultural activities based on a set of agricultural activity profiles, in accordance with the present disclosure;

FIG. 4 illustrates an exemplary schematic representation of generating an agricultural activity sequence for a period of observation based on agricultural activities determined for each subset of the period of observation, in accordance with an embodiment of the present disclosure;

FIG. 5 illustrates a schematic representation of an activity-segment sequence, in accordance with an embodiment of the present disclosure; and

FIG. 6 illustrates a flow chart for addressing short segment condition, in accordance with an embodiment of the present disclosure.

It should be appreciated by those skilled in the art that any block diagram herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computing device or processor, whether or not such computing device or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Before setting forth the detailed explanation, it is noted that all of the discussion below, regardless of the particular implementation being described, is exemplary in nature, rather than limiting.

Farm activities may not always be recorded or observed unless they occur for prolonged periods of time or happen to be recorded diligently. Traceability of agricultural activities is very critical to market compliance. The methods of the present disclosure provide an automated simple and flexible means for identifying crop protocol irrespective of the type of crop under consideration and agricultural activities associated thereof. Real time monitoring of the agricultural activities by use of sensors deployed strategically throughout the farm, farm equipment or as wearable devices ensures that no activity, however minor is missed. Again, large amount of dynamic data collected is analyzed based on factors such as time period when it was collected, location data associated with the collected data and also historic data associated with the farm for the crop under consideration. These factors ensure that the collected data can be analyzed effectively to conclude on the various agricultural activities that may be associated for each subset of time period in the total period under consideration. The agricultural activities are then fused to obtain an activity-segment sequence for identifying an observed crop protocol. The systems and methods of the present disclosure provide various embodiments for fusing determined agricultural activities such that only anomalously determined agricultural activities are ignored. Methods and systems of the present disclosure further enable farm personnel to conclude on effects of dynamic changes in crop protocol. This allows continuous building up of the repository of agro-climatic zone based information associated with the farm. Regulating crop protocol results in a predictable increase in efficiency and sustainability of crop yield that helps farm personnel to optimize productivity.

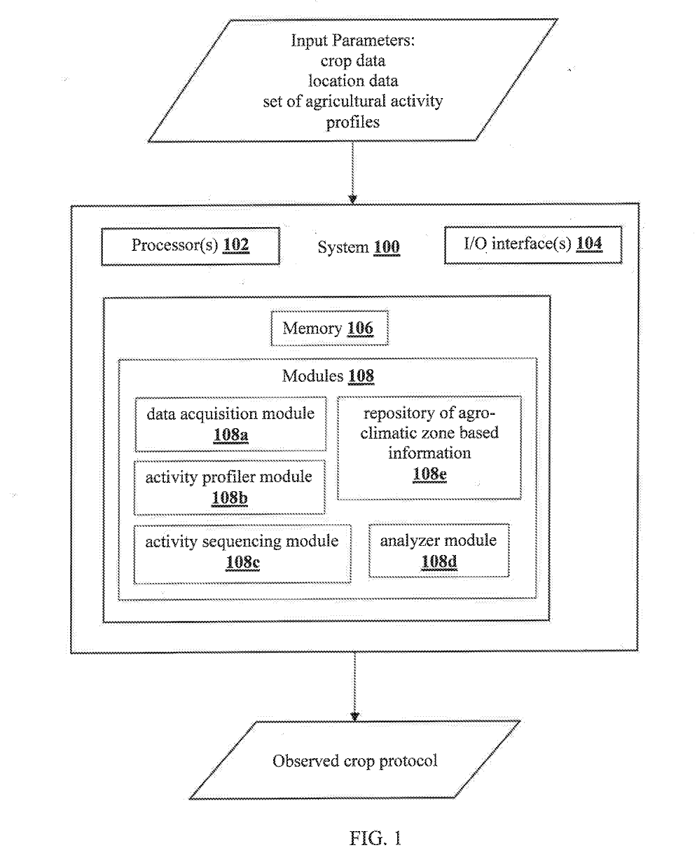

Referring now to the drawings, and more particularly to FIGS. 1 through 6, where similar reference characters denote corresponding features consistently throughout the figures, there are shown preferred embodiments and these embodiments are described in the context of the following exemplary system and method.

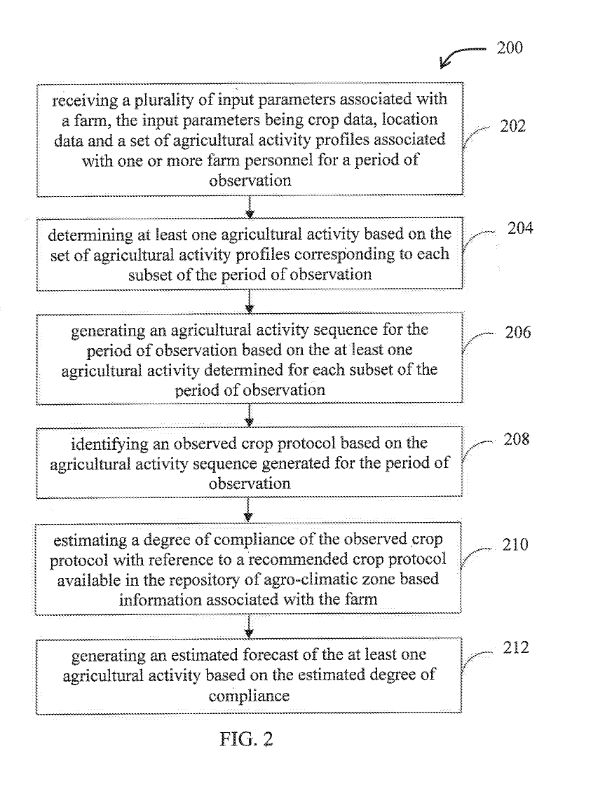

FIG. 1 illustrates a block diagram of a system 100 for estimating degree of compliance with recommended crop protocol and FIG. 2 is an exemplary flow diagram illustrating a computer implemented method 200 for estimating degree of compliance with recommended crop protocol using the system 100 in accordance with an embodiment of the present disclosure.

In an embodiment, the system 100 includes one or more processors 102, communication interface device(s) or input/output (I/O) interface(s) 104, and memory 106 or one or more data storage devices comprising one or more modules 108 operatively coupled to the one or more processors 102. The one or more processors are hardware processors that can be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory. In an embodiment, the system 100 can be implemented in one or more computing systems, such as a laptop computer, a desktop computer, a notebook, a workstation, a mainframe computer, a server, a network server, cloud, hand-held device, wearable device and the like.

The I/O interface device(s) 104 can include a variety of software and hardware interfaces, for example, a web interface, a graphical user interface, IOT interface, and the like and can facilitate multiple communications within a wide variety of networks and protocol types, including wired networks, for example, LAN, cable, etc., and wireless networks, such as WLAN, cellular, or satellite. In an embodiment, the I/O interface device(s) 104 can include one or more ports for connecting a number of devices to one another or to another server.

The memory 106 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, various functional modules 108a through 108e (of FIG. 1) of the system 100 can be stored in the memory 106 as illustrated.

The steps of the computer implemented method 200 will now be explained with reference to the components of the system 100 as depicted in FIG. 1. In an embodiment, a data acquisition module 108a is configured to, at step 202, receive a plurality of input parameters associated with a farm, the input parameters being crop data, location data and a set of agricultural activity profiles associated with one or more farm personnel for a period of observation, the period of observation typically being a cultivation cycle. Crop data typically includes all information pertaining to a crop such as name of the crop, variety of the crop, and the like. Location data may refer to any known indicator of a location including an accurate location such as Global Positioning System (GPS) location and also general indicators like name of a village or locality. In an embodiment, An agricultural activity profile for a farm personnel for a given period of time is a collection of sample-sets where each sample-set is a series of values obtained from sensors such as accelerometer, gyroscope, magnetometer, and the like may be deployed as at least one of (a) wearable devices and (b) farm or farm equipment mounted devices. Alternatively, one or more of the plurality of input parameters may be obtained by crowdsourcing from farm personnel associated with the farm. Crowdsourcing data pertaining to agricultural activity from more than one farmer personnel helps to establish agricultural activity for any given period of time in a fault-tolerant manner i.e. even if a few farmer personnel are not following the crop protocol recommendation, the overall agricultural activity recognition exercise for the given period of time is not hampered.

An agricultural activity profile for an exemplary agricultural activity may include acceleration values sensed at various instants of time along the various axes as shown herein below:

| A | B | C | D | |
|---|---|---|---|---|
| Sensor | Accel-1 | Accel-1 | Accel-3 | E |
| values | X-axis | Y-axis | Z-axis | . . . |
| Time-0 | −15 | −10 | −10 | . . . |
| Time-1 | −15 | −15 | 15 | . . . |
| Time-2 | 15 | 10 | −10 | . . . |
| Time-3 | 10 | 10 | 8 | . . . |
| Time-4 | 20 | 15 | 15 | . . . |
| Time-5 | 3 | 3 | 3 | . . . |

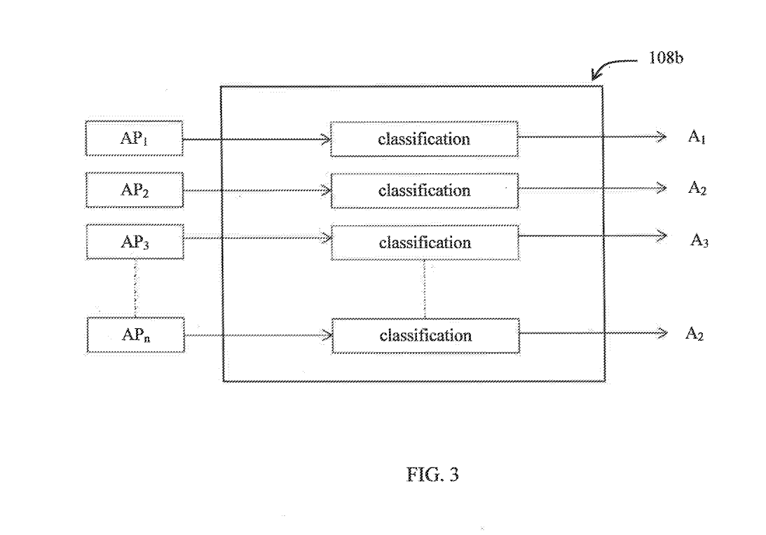

In an embodiment, an activity profiler module 108b is configured to, at step 204, determine at least one agricultural activity based on the set of agricultural activity profiles corresponding to each subset of the period of observation, the subset of the period of observation being a pre-defined period such as a day or half day or pre-defined number of hours. Let there be a set of n farmer personnel (n>=1) from whom agricultural activity profile may be received daily for a given period of k (k>=1) days. For any given day, the data acquisition module 108a receives all the agricultural activity profiles as input and sends to the activity profiler module 108b that determines one or more agricultural activities as an output. FIG. 3 is an exemplary schematic representation of determining one or more agricultural activities based on a set of agricultural activity profiles, in accordance with the present disclosure. The agricultural activity corresponding to each farm personnel's agricultural activity profile is analyzed to determine an associated agricultural activity. In an embodiment, the step of determining at least one agricultural activity comprises use of supervised-learning based classifiers configured to learn and identify an agricultural activity associated with an agricultural activity profile. Examples of agricultural activities include sowing, weeding, harvesting, and the like. A supervised-learning based classifier is trained to recognize agricultural activities separately with the help of corresponding activity profiles. Once trained, the classifier can recognize a new agricultural activity when presented with a new activity profile.

Once an agricultural activity is determined for each of the n farm personnel by iterating the step 204 for each agricultural activity profile, say three agricultural activities A1, A2 and A3 are identified. There may be a scenario, wherein for the given subset of the period of observation, based on a repository of agro-climatic zone based information 108e, it is know that one or more of agricultural activities A1, A2 and A3 correspond to the actual agricultural activity, which ideally should be in conformance with a recommended crop protocol in the repository 108e.

Given that the frequency-set for the three activities is {F1, F2, F3}, a major activity. Ai is the one with frequency Fi where Fi=arg max{F1, F2, F3}. The activity profiler module 108b tags the given subset of the period of observation with the activity Ai. Accordingly, in accordance with the present disclosure, the one or more agricultural activity corresponds to the agricultural activity having a maximum frequency of occurrence identified for the subset of the period or a frequency of occurrence greater than a pre-defined threshold frequency for the subset of the period of observation based on the repository of agro-climatic zone based information 108e associated with the farm. It is possible that there is another scenario wherein more than one agricultural activity is identified having a highest frequency or having a frequency greater than the pre-defined threshold frequency. In such a case, each subset of the period of observation (say a day d) is tagged with the list of agricultural activities A_list(d).

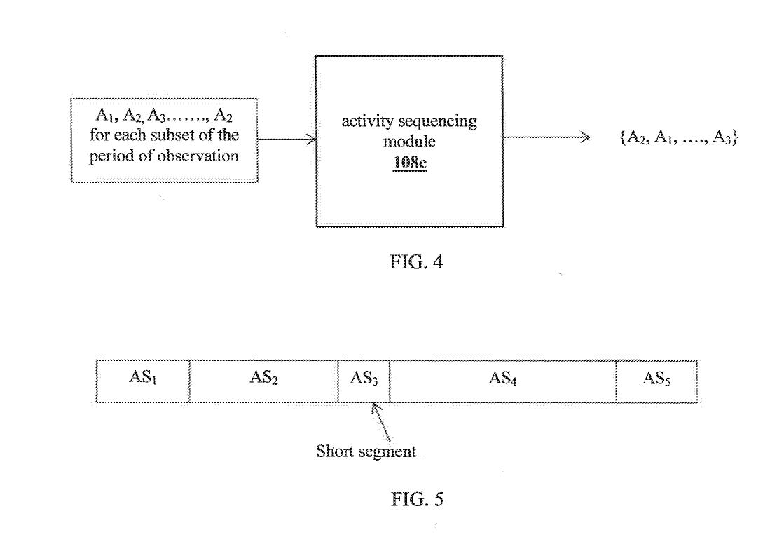

In an embodiment, an activity sequencing module 108c is configured to, at step 204, generate an agricultural activity sequence for the period of observation based on the one or more agricultural activities determined for each subset of the period of observation. FIG. 4 illustrates an exemplary schematic representation of generating an agricultural activity sequence for a period of observation based on agricultural activities determined for each subset of the period of observation, in accordance with an embodiment of the present disclosure. The step of generating an agricultural activity sequence for the period of observation comprises generating a sequence of activity-segments (AS₁, AS₂, . . . ASₙ) the activity-segments being associated with the identified agricultural activity, the subset of the period of observation associated thereof and the location data associated thereof.

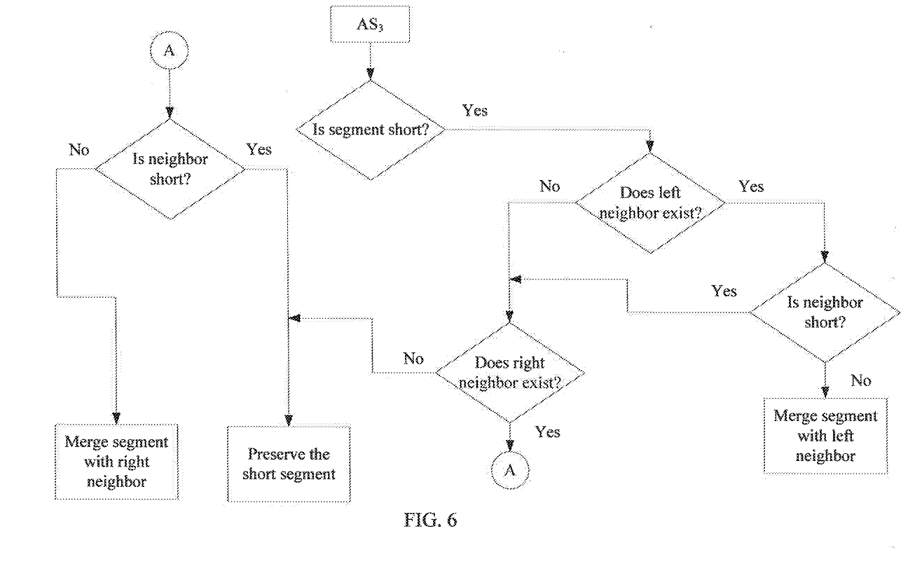

In an embodiment, an analyzer module 108d is configured to, at step 208, identify an observed crop protocol based on the agricultural activity sequence generated for the period of observation. To identify the observed crop protocol from the activity-segments (AS₁, AS₂, . . . ASₙ), two or more activity-segments are fused. In a first iteration, all neighboring agricultural activities tagged with a same value are fused into the same activity-segment. Say a few subsets of the period of observation are tagged to agricultural activity weeding (say A₁), a fused segment, say AS₁ may represent a phase of the period of observation during which agricultural activity weeding was performed. For subsets of the period of observation wherein the list of agricultural activities A_list(d) was generated, there was no clear agricultural activity having a clear majority. In such a scenario, if one of the agricultural activities, in the A_list(d) is also a neighboring agricultural activity, that agricultural activity is chosen as a major activity. If the neighbors on either side are contained in the A_list(d), one of them is chosen as the activity for that subset of the period of observation based on its position in an ordered list of ail agricultural activities available in the repository of agro-climatic zone based information 108e. Any geography is typically divided into a set of agro-climatic zones. For each agro-climatic zone, a list of crops and the associated crop protocols are defined. The repository of agro-climatic zone based information 108e includes a glossary of crops and the associated crop protocols for all agro-climatic zones. Thus the system 100 is enriched by the repository of agro-climatic zone based information 108e and hence provided with a history of crops grown in various agro-climatic zones of the country. At any given point of time, the repository of agro-climatic zone based information 108e provides a minimum possible length l of any crop-protocol stage or activity-segment. Accordingly, in accordance with an embodiment of the present disclosure, two or more activity-segments (AS₁, AS₂, . . . ASₙ) are fused to form an activity-segment sequence based on likeness of the associated at least one agricultural activity, the subset of the period of observation associated thereof, the location data associated thereof and position of the at least one agricultural activity in the agricultural activity sequence. FIG. 5 illustrates a schematic representation of an activity-segment sequence, in accordance with an embodiment of the present disclosure.

If the length of the activity-segment is less than the minimum possible length l, the activity-segment may be referred to as a short segment. In order to identify the short segments, the fusing of the activity-segments is continued iteratively from left to right and each short segment is tagged as short segment for further analyses. FIG. 6 illustrates a flow chart for addressing short segment condition, in accordance with an embodiment of the present disclosure. The method of FIG. 6 is applied to each short segment of the activity-segment sequence, from left to right. For each segment, either a fusion happens with a neighboring activity-segment or there is no change, wherein the short segment may be anomalous or actually an intended short phase agricultural activity. In an embodiment, the analyzer module 108d is configured to identify anomalous agricultural activity in the activity-segment sequence based on length of the activity-segment, position of the activity-segment and the agro-climatic zone based information associated with the farm. Based on the position of the activity-segment and information in the agro-climatic zone based information on whether the agricultural activity associated with the short segment is valid based on the associated crop protocol, the short segment may be identified as anomalous.

In an embodiment, the repository of agro-climatic zone based information 108e provides an order in which crop stages occur, which is independent of the exact stage of the crop. To ensure that the stages in the observed crop protocol meets these generic requirements, the system 100 maintains for each agricultural activity A₁, A₂, . . . Aₙ, a list of agricultural activities called prev_list(A) that necessarily occur before each of the agricultural activities. For any activity B other than A, B is in prev_list(A) if (a) every crop protocol containing A also contains activity B, and (b) B always comes before A. A and prev_list(A) for all agricultural activities are contained in the repository of agro-climatic zone based information 108e.

Ideally, for each activity segment ASₓ in {AS₁, . . . , AS₅) of FIG. 5, prev_list(ASₓ) contains the activity-segments listed before it. While scanning the activity-segments in a sequence from left to right, if a segment X is preceded by a set of segments that are listed in prev_list(X), then X is called satisfiable. If there is at least one segment Y which is not in prev_list(X), then X is called unsatisfiable. For instance, segment AS₅ is unsatisfiable if AS₄ does not appear in prev_list(AS₅). AS₄ in this case is called an out of order activity. The list is scanned from left to right, and all out of order activities are either merged with the largest (in length) neighboring satisfiable activity or a left activity if both neighbors are of the same size and satisfiable. The resulting activity-segment sequence is the observed crop protocol.

The step 208 thus identifies the observed crop protocol for a crop under consideration for a given period of observation. The recommended crop protocol for the crop under consideration for the given period of observation is available in the repository of agro-climatic zone based information 108e. In an embodiment, the analyzer module 108d is configured to, at step 210, estimate a degree of compliance of the observed crop protocol with reference to the recommended crop protocol. In accordance with the present disclosure, deviation, if any, of the observed crop protocol from the recommended crop protocol is estimated to flag the degree of compliance through a score. It is assumed for the sake of computation that the observed crop protocol and the recommended crop protocol are aligned or have the same start time. For example, the deviation between a recommended crop protocol having activity-segment sequence of {sowing:d₁, weeding:d₂, harvesting:d₃} and the observed crop protocol having activity-segment sequence of {sowing:d₄, weeding:d₅, harvesting:d₅} is given a score, where each element is of the form activity:d_{X} with d_{X} indicating duration of the agricultural activity. The difference in duration is used to compute the score (S) given as: S=1−(1/n) Σᵢ|dₙ₊ᵢ−dᵢ|/D, for length n (number of stages or activity-segments) of the recommended crop protocol, wherein D refers to maximum possible length of an activity-segment or stage. So a perfectly compliant system has a score 1.

There are two possible scenarios during comparison of the observed crop protocol with the recommended crop protocol. Firstly, the observed crop protocol may not have an activity-segment that the recommended crop protocol has. To resolve this, a stage with length 0 is assumed for the observed crop protocol. Secondly, the observed crop protocol may have one or more stages (k₁, k₂, . . . kⱼ) which are not available in the recommended crop protocol. The deviation score is penalized in this case by subtracting a known constant, mean duration mean_d(kⱼ) for each such activity-segment (stage) in the observed crop protocol which is not available in the recommended crop protocol. In an embodiment, the mean duration is defined based on the recommended crop protocol stage lengths available in the repository of agro-climatic zone based information 108e. So, the resultant score is given as:

S=1−(1/n)Σᵢ|dₙ₊ᵢ−dᵢ|/D−S=1−(1/n)Σⱼ(kⱼ)/D

Thus, output of step 210 includes a list of stages in the recommended crop protocol that do not occur in the observed crop protocol, and a list of stages in the observed crop protocol that do not occur in the recommended crop protocol. Differences between the observed crop protocol and the recommended crop protocol are indicative of the dynamic changes in the crop protocol. Thus, in accordance with the present disclosure, the degree of compliance is estimated by comparing the at least one agricultural activity associated with an activity-segment length in the period of observation with the corresponding at least one agricultural activity in the recommended crop protocol; assigning a deviation score based on the comparison; and concluding on dynamic changes in crop protocol associated with a crop under consideration based on the one or more activity segments that do not form part of both the activity-segment sequence of the observed crop protocol and the recommended crop protocol.

In an embodiment, the analyzer module 108d is configured to, at step 212, generate an estimated forecast of the at least one agricultural activity based on the estimated degree of compliance. Correlating the observed crop protocol with the recommended protocol may be used to generate an estimate of the future activities if the compliance is good. This can be provided as an input to the market or, agri-input companies to be ready for next orders or upcoming transactions. For instance, if the observed crop protocol is noted to be compliant with the recommended crop protocol during initial stages of the cultivation cycle (say weeding, sowing, fertilizer application), the farm personnel may safely assume the expected time for the future activities (say harvesting), thereby enabling proactive planning (manpower, suppliers) for the future activities.

In an embodiment, the analyzer module 108d is configured to, at step 214 (not shown), define the observed crop protocol as the recommended crop protocol for the crop under consideration if crop yield associated with the observed crop protocol is greater than crop yield associated with the recommended crop protocol in the repository of agro-climatic zone based information 108e associated with the farm. Thus, in accordance with the present disclosure, there is a continuous building up of the repository of agro-climatic zone based information 108e thereby providing farm personnel with an enriched and accurate database that may be utilized for optimizing productivity.

In an embodiment, the system 100 has a distributed architecture with one or more modules being provided local to the farm and having at least a set of computation such as steps 202 and 204 being performed locally while steps 206 through steps 212 described herein above are performed on a remote central server.

The written description describes the subject matter herein to enable any person skilled in the art to make and use the embodiments of the invention. The scope of the subject matter embodiments defined here may include other modifications that occur to those skilled in the art. Such other modifications are intended to be within the scope if they have similar elements that do not differ from the literal language of the claims or if they include equivalent elements with insubstantial differences from the literal language.

The scope of the subject matter embodiments defined here may include other modifications that occur to those skilled in the art. Such other modifications are intended to be within the scope if they have similar elements that do not differ from the literal language of the claims or if they include equivalent elements with insubstantial differences from the literal language.

It is, however to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments of the present disclosure may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules comprising the system of the present disclosure and described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The various modules described herein may be implemented as software and/or hardware modules and may be stored in any type of non-transitory computer readable medium or other storage device. Some non-limiting examples of non-transitory computer-readable media include CDs, DVDs, BLU-RAY, flash memory, and hard disk drives.

Further, although process steps, method steps, techniques or the like may be described in a sequential order, such processes, methods and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein.

Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It is intended that the disclosure and examples be considered as exemplary only, with a true scope and spirit of disclosed embodiments being indicated by the following claims.

What is claimed is:

1. A processor implemented method (200) comprising:
receiving, by a data acquisition module, a plurality of input parameters associated with a farm, the input parameters being crop data, location data and a set of agricultural activity profiles associated with one or more farm personnel for a period of observation (202);
determining, by an activity profiler module, at least one agricultural activity based on the set of agricultural activity profiles corresponding to each subset of the period of observation (204);
generating, by an activity sequencing module, an agricultural activity sequence for the period of observation based on the at least one agricultural activity determined for each subset of the period of observation (206); and
identifying, by an analyzer module, an observed crop protocol based on the agricultural activity sequence generated for the period of observation (208).

2. The processor implemented method of claim 1, wherein one or more of the plurality of input parameters are obtained from at least one of:
sensors deployed as at least one of (a) wearable devices and (b) farm or farm equipment mounted devices; and
crowdsourcing from farm personnel associated with the farm.

3. The processor implemented method of claim 1, wherein the step of determining at least one agricultural activity comprises use of supervised-learning based classifiers configured to learn and identify an agricultural activity associated with an agricultural activity profile.

4. The processor implemented method of claim 1, wherein the at least one agricultural activity corresponds to the agricultural activity having a maximum frequency of occurrence identified for the subset of the period or a frequency of occurrence greater than a pre-defined threshold frequency for the subset of the period of observation based on a repository of agro-climatic zone based information associated with the farm.

5. The processor implemented method of claim 4, wherein the step of generating an agricultural activity sequence for the period of observation comprises generating a sequence of activity-segments, the activity-segments being associated with the identified at least one agricultural activity, the subset of the period of observation associated thereof and the location data associated thereof.

6. The processor implemented method of claim 5, wherein the step of identifying an observed crop protocol comprises:
fusing two or more activity-segments to form an activity-segment sequence based on likeness of the associated at least one agricultural activity, the subset of the period of observation associated thereof, the location data associated thereof and position of the at least one agricultural activity in the agricultural activity sequence; and
identifying anomalous agricultural activity in the activity-segment sequence based on length of the activity-segment, position of the activity-segment and the agro-climatic zone based information associated with the farm.

7. The processor implemented method of claim 6 further comprising estimating, by the analyzer module, a degree of compliance of the observed crop protocol with reference to a recommended crop protocol available in the repository of agro-climatic zone based information associated with the farm (210).

8. The processor implemented method of claim 7, wherein the step of estimating a degree of compliance comprises:
comparing the at least one agricultural activity associated with an activity-segment length in the period of observation with the corresponding at least one agricultural activity in the recommended crop protocol;
assigning a deviation score based on the comparison; and
concluding on dynamic changes in crop protocol associated with a crop under consideration based on the one or more activity segments that do not form part of both the activity-segment sequence of the observed crop protocol and the recommended crop protocol.

9. The processor implemented method of claim 7 further comprising generating, by the analyzer module, an estimated forecast of the at least one agricultural activity based on the estimated degree of compliance (212).

10. The processor implemented method of claim 7 further comprising defining, by the analyzer module, the observed crop protocol as the recommended crop protocol for the crop under consideration if crop yield associated with the observed crop protocol is greater than crop yield associated with the recommended crop protocol in the repository of agro-climatic zone based information associated with the farm (214).

11. A system (100) comprising:
one or more processors (102); and
one or more internal data storage devices (106) operatively coupled to the one or more processors (102) for storing instructions configured for execution by the one or more processors (102), the instructions being comprised in:
a data acquisition module (108a) configured to receive a plurality of input parameters associated with a farm, the input parameters being crop data, location data and a set of agricultural activity profiles associated with one or more farm personnel for a period of observation;
an activity profiler module (108b) configured to determine at least one agricultural activity based on the set of agricultural activity profiles corresponding to each subset of the period of observation, the at least one agricultural activity corresponding to the agricultural activity having a maximum frequency of occurrence identified for the subset of the period or a frequency of occurrence greater than a pre-defined threshold frequency for the subset of the period of observation based on a repository of agro-climatic zone based information (108e) associated with the farm;
an activity sequencing module (108c) configured to generate an agricultural activity sequence for the period of observation based on the at least one agricultural activity determined for each subset of the period of observation; and
an analyzer module (108d) configured to identify an observed crop protocol based on the agricultural activity sequence generated for the period of observation.

12. The system of claim 11, wherein one or more of the plurality of input parameters are obtained from at least one of:
sensors deployed as at least one of (a) wearable devices and (b) farm or farm equipment mounted devices; and
crowdsourcing from farm personnel associated with the farm.

13. The system of claim 11, wherein the activity profiler module (108b) is further configured to determine the at least one agricultural activity by using supervised-learning based classifiers configured to learn and identify an agricultural activity associated with an agricultural activity profile.

14. The system of claim 11, wherein the activity sequencing module (108c) is further configured to generate the agricultural activity sequence for the period of observation by generating a sequence of activity-segments, the activity-segments being associated with the identified at least one agricultural activity, the subset of the period of observation associated thereof and the location data associated thereof.

15. The system of claim 7, wherein the analyzer module (108d) is further configured to perform one or more of
identifying the observed crop protocol by:
fusing two or more activity-segments to form an activity-segment sequence based on likeness of the associated at least one agricultural activity, the subset of the period of observation associated thereof, the location data associated thereof and position of the at least one agricultural activity in the agricultural activity sequence; and
identifying anomalous agricultural activity in the activity-segment sequence based on length of the activity-segment, position of the activity-segment and the agro-climatic zone based information associated with the farm;
estimating a degree of compliance of the observed crop protocol with reference to a recommended crop protocol available in the repository of agro-climatic zone based information associated with the farm by:
comparing the at least one agricultural activity associated with an activity-segment length in the period of observation with the corresponding at least one agricultural activity in the recommended crop protocol;
assigning a deviation score based on the comparison; and
concluding on dynamic changes in crop protocol associated with a crop under consideration based on the one or more activity segments that do not form part of both the activity-segment sequence of the observed crop protocol and the recommended crop protocol;
generating an estimated forecast of the at least one agricultural activity based on the estimated degree of compliance; and
defining the observed crop protocol as the recommended crop protocol for the crop under consideration if crop yield associated with the observed crop protocol is greater than crop yield associated with the recommended crop protocol in the repository of agro-climatic zone based information associated with the farm.

16. A computer program product comprising a non-transitory computer readable medium having a computer readable program embodied therein, wherein the computer readable program, when executed on a computing device, causes the computing device to:
receive a plurality of input parameters associated with a farm, the input parameters being crop data, location data and a set of agricultural activity profiles associated with one or more farm personnel for a period of observation;
determine at least one agricultural activity based on the set of agricultural activity profiles corresponding to each subset of the period of observation;
generate an agricultural activity sequence for the period of observation based on the at least one agricultural activity determined for each subset of the period of observation; and
identify an observed crop protocol based on the agricultural activity sequence generated for the period of observation.

17. The computer program product of claim 16, wherein the computer readable program further causes the computing device to perform one or more of:
estimating a degree of compliance of the observed crop protocol with reference to a recommended crop protocol available in the repository of agro-climatic zone based information associated with the farm;
generating an estimated forecast of the at least one agricultural activity based on the estimated degree of compliance; and
defining the observed crop protocol as the recommended crop protocol for the crop under consideration if crop yield associated with the observed crop protocol is greater than crop yield associated with the recommended crop protocol in the repository of agro-climatic zone based information associated with the farm.
